(19) United States
(12) Patent Application Publication
(10) Pub. No.: US 2005/0177957 A1
(43) Pub. Date: Aug. 18, 2005

(54) Topical treatment for carpet and textiles and topically treated carpet and textile products

(76) Inventor: Jack W Long, White, GA (US)

Correspondence Address: MILES & STOCKBRIDGE PC, 1751 PINNACLE DRIVE, SUITE 500, MCLEAN, VA, 22102-3833, US

(21) Appl. No.: 10/500,897

(22) PCT Filed: Jan. 7, 2003
(86) PCT No.: PCT/US03/00260

Related U.S. Application Data
(60) Provisional application No. 60/344,790, filed on Jan. 7, 2002.

(51) Int. Cl. D06M 10/00; C11D 1/00

(52) U.S. Cl. 8/115.51; 510/278

(57) ABSTRACT

A composition to be used as a topical treatment for carpet and textiles, and a process for producing the composition are provided. The composition has desirable antibacterial, antimicrobial, and antifungal properties, and is made up of an effective amount of an antimicrobial agent having a blend of substituted ammonium salts of alkylated phosphoric acids admixed with free alkylated phosphoric acid, an effective amount of a pesticide containing Permethrin, a sufficient amount of an emulsifier in the form of an ammonium nonylphenol ether sulfate, and, optionally, an effective amount of a fragrance additive, all mixed with water. The process involves premixing with water the emulsifier, the antimicrobial agent, and, where used, the fragrance additive, adding this premix to a larger quantity of water, agitating the composition, slowly adding the pesticide while agitating, and continuing the agitation for a predetermined period of time.

### BACKGROUND OF THE INVENTION

1. Field of the Invention

The present invention is directed to a treatment solution to be applied topically to carpet, textile, and similar products, and more specifically to a topical treatment containing antibacterial and antifungal agents for maintaining the “freshness” of the carpet or textile product.

2. Description of Related Art

The carpet and textile industries have implemented various topical treatments for those goods to provide various desired product characteristics, such as resistance to staining and the like. Carpet and textiles, particularly upholstery fabric used on furniture, generally remains in use for several to many years in homes and various commercial settings. The carpet and upholstery is difficult to clean, and generally must be cleaned in place. Steam cleaning with various cleaning solutions will generally remove dirt and other particulates from the goods, as well as removing stains.

There exists a need to further improve the cleanliness or freshness of carpet and upholstery, above and beyond the periodic cleaning of those goods. Because these products remain in place for extended period of time, and come into frequent contact with many agents which can foul the carpet or upholstery in numerous ways, a need exists to provide the carpet or upholstery with the capability to resist these potential foulants over an extended period of time. In particular, a need exists to provide these materials with the ability to resist the growth of bacteria and fungi, to thereby maintain the freshness of the materials. In addition, it is desirable to provide the carpet or upholstery with antimicrobial properties which will kill, for example, dust mites or other pests, which can insinuate themselves in the carpet or upholstery.

It is therefore a principal object of the invention to provide a topical treatment for carpet and upholstery products which imparts the desired antibacterial, antifungal, and antimicrobial characteristics to the carpet or upholstery.

It is a further principal object of the invention to provide carpet and upholstery goods which have been treated such that they have desired antibacterial, antifungal, and anti-microbial properties.

It is an additional object of the present invention to provide a process for producing a topical treatment concentrate, and for treating a carpet or textile product therewith, to impart the desired properties in the product.

### SUMMARY OF THE INVENTION

The above and other objects of the present invention are achieved in the present invention by providing a treatment solution suitable for topical application to carpet products and textile products (principally upholstery products, in the case of textile products) which imparts antibacterial, antifungal and antimicrobial properties to the carpet or upholstery. The particular topical treatment solution developed has been demonstrated to have long-lasting effects, making it especially suitable for carpet and upholstery, which remain in service for extended periods either without cleaning being performed, or with only infrequent cleaning being performed. The treatment solution is a blend or mixture of various agents which impart the desired properties to the carpet or upholstery.

### DETAILED DESCRIPTION OF THE PREFERRED EMBODIMENT

In a preferred embodiment of the present invention, the topical treatment solution is first prepared as a concentrate, with the concentrate being made up of a stable emulsion in water of an antimicrobial compound, a pesticide which is active against dust mites, an emulsifier, and a fragrance additive. As used herein, the term “antimicrobial” is intended to refer to the ability to inhibit or retard the growth of a wide range of microorganisms, including Gram-positive and Gram-negative bacteria, and vegetative fungi. In addition, an antimicrobial compound according to the present invention may also be effective at killing or inhibiting certain viruses.

A preferred antimicrobial compound used in the treatment solution of the present invention is a blend of substituted ammonium salts of alkylated phosphoric acids admixed with free alkylated phosphoric acid, marketed under the trademark/trade name INTERSEPT®, by Intersept Specialty Products of Kennesaw, Ga., which is an operating division of Interface, Inc., of LaGrange, Ga. INTERSEPT® i s registered under Environmental Protection Agency No. 043670-1. U.S. Pat. Nos. 4,935,232, 5,032,310 and 5,474,739, assigned to Interface, Inc., all of which are hereby expressly incorporated by reference, disclose microbiocidal compositions of this type.

A preferred pesticide for the treatment solution contains Permethrin, (3-Phenoxyphenyl)methyl(±)cis-trans 3-(2,2-dichloroethenyl)-2,2-dimethylcyclopropanecarboxylate, as an active ingredient. One commercially available product is SMITE EC-10, which contains Permethrin as an active ingredient at a concentration of 10% by weight. SMITE EC-10 was registered at the U.S. Environmental Protection Agency by Hugh Payton, M. D., and Medachieve, Inc., both of Washington Court House, Ohio, and the product is available from Medachieve, Inc.

The treatment solution further preferably contains an emulsifier which aids in maintaining the concentrate in a stable emulsion. An emulsifier which has been found to be suitable for use is RHODAPEX® CO-436, which is an ammonium nonylphenol ether sulfate that is available commercially from the Home, Personal Care, and Industrial Ingredients Group of Rhodia, based in Cranberry, N.J. Other emulsifiers may be suitable for use in this concentrate, as well.

The treatment solution may, in addition to these ingredients, preferably contain a fragrance to aid in maintaining a pleasant smell in the carpet or upholstery. One suitable fragrance which has been used in developing the present invention is a “clean and fresh” fragrance, No. AA 013175, produced by Arylessence, Inc., of Marietta, Ga. Other fragrances may be used in place of the one identified, and it is believed that at least oil-based fragrances will not adversely impact the stability of the concentrated emulsion. Other than this consideration, the selection of a fragrance is subjective, and can be based upon what is commonly believed to be a desirable fragrance in a particular part of the world. The treatment solution concentrate may optionally be produced without any fragrance additive.

A preferred composition of the treatment solution concentrate in the form that it would be produced commercially is:

| Ingredient | wt. % |
|---|---|
| Intersept (antimicrobial) | 0.010 |
| Rhodapex CO-436 (emulsifier) | 0.020 |
| AA 013175 (fragrance) | 0.017 |
| SMITE EC-10 (pesticide) | 4.15 |
| Water | 95.803 |

The ranges of concentration of each of the ingredients may be varied. For example, each of the antimicrobial, binder, and fragrance may vary from somewhat below the stated weight percentage, up to, for example, 1.0 weight percent. The pesticide may be present in a range of, for example, 2-10 weight percent. The above preferred concentrate composition is one which has been formulated and which, when further diluted at a 10 parts water to 1 part concentrate, produces a solution which is then topically applied to carpet or upholstery, and has been shown to effectively produce the desired characteristics in the treated product. This topical treatment has also demonstrated that it is capable of having long-term effectiveness, for example, on the order of several years.

Some degree of care must be taken in producing or manufacturing the treatment solution concentrate. In particular, the order of addition of the ingredients is important, in order that a stable emulsion may be formed. The below formulation is based upon the production of 1000 lbs. of the concentrate.

In a premix step, 0.17 lb. of the Fragrance (AA013175), 0.10 lb. of the antimicrobial (Intersept), and 0.20 lb. of the emulsifier (Rhodapex), are mixed with 6.197 lb. of water, in either a commercial-scale mixer or a laboratory-scale mixer, to form a premix. In a commercial-scale stainless steel mixer, 951.833 lbs. of water are introduced into the mixer, and then the premix described above is added to the water. Subsequently, the pesticide (Smite EC-10) is slowly added, while the mixture is well agitated. The stirring/agitation is continued for approximately ten (10) minutes, and then stopped. This procedure produces a stable emulsion to be shipped as a concentrate.

The pH of the concentrate is preferably in the range of 7.0-9.0, and this is generally preferably checked at the end of the process. In addition, it is desired that the concentrate meet the specification that the percentage of solids after maintaining the concentrate at 135EC. for 20 minutes, is about 0.5 to about 0.8.

As noted previously, for the expected normal usage of this concentrate as a topical treatment for carpet and upholstery, the concentrate prepared as above will be diluted in water, in the ratio of about 1 part concentrate to 10 parts water. This resulting solution may preferably be applied to the material at the rate/quantity of about one gallon per about 180 square feet of area. This level of application has been found to provide acceptable long-lasting effects in resisting the foulants discussed herein. A less-diluted solution, and/or a heavier application of the solution, may be used when economically viable, and further improved resistance can be expected. The solution is preferably applied via a spray mechanism of a type commonly known for use in applying topical solutions to products of this type. Alternatively, immersion techniques may also be employed, in that the topical treatment is generally applied prior to the upholstery being installed on the furniture pieces, or before a carpet product is installed on subflooring.

1. A composition having antibacterial, antimicrobial, and antifungal properties, for topical treatment of carpet or textile products, comprising an admixture of:
(a) an effective amount of an antimicrobial agent comprising a blend of substituted ammonium salts of alkylated phosphoric acids admixed with free alkylated phosphoric acid;
(b) an effective amount of a pesticide containing Permethrin; and
(c) a sufficient amount of an emulsifier to maintain a stable emulsion.

2. A composition according to claim 1, wherein the composition contains an effective amount of a fragrance additive.

3. A composition according to claim 1, wherein the emulsifier comprises an ammonium nonylphenol ether sulfate.

4. A composition according to claim 1, wherein the composition is prepared in the form of a concentrate, which is to be diluted in water prior to topical application on carpet or textile products.

5. A composition according to claim 4, wherein the concentrate comprises about 2-10 weight percent of the pesticide.

6. A composition according to claim 5, wherein the concentrate comprises about 0.010-1.0 weight percent of the antimicrobial agent.

7. A composition according to claim 6, wherein the concentrate comprises about 0.020-1.0 weight percent of the emulsifier.

8. A composition according to claim 7, wherein the concentrate further comprises a fragrance additive, said fragrance additive being present in a range of about 0.017-1.0 weight percent, and the balance of the concentrate is water.

9. A composition according to claim 8, wherein the concentrate is diluted in water to produce a solution to be topically applied.

10. A composition according to claim 9, wherein the dilution of the concentrate is at a level of 10 parts water to 1 part concentrate.

11. A carpet product topically treated with the composition of claim 1.

12. A textile product topically treated with the composition of claim 1.

13. A textile product according to claim 12, wherein the textile product is an upholstery textile.

14. A process for producing a composition having antibacterial, antimicrobial, and antifungal properties, for topical treatment of carpet or textile products, the process comprising, in order, the steps of:
(a) premixing with water an effective amount of a fragrance, and effective amount of an emulsifier, and an effective amount of an antimicrobial agent comprising a blend of substituted ammonium salts of alkylated phosphoric acids admixed with free alkylated phosphoric acid;
(b) adding the premix of step (a) to a larger quantity of water; and
(c) agitating the thus-formed composition;
(d) slowly adding an effective amount of a pesticide containing Permethrin; and
(e) continuing the agitation for a predetermined period of time.

15. A process according to claim 14, wherein the composition produced is a concentrate of a solution to be topically applied to carpet or textile products.
